(19) United States
(12) Patent Application Publication
(10) Pub. No.: US 2023/0408221 A1
(43) Pub. Date: Dec. 21, 2023

(54) METHOD FOR MAKING A GUN FRAME BY HIGH ENERGY BEAM WELDING COMPLEMENTARY METAL FRAMES ALONG A COMMON SAGITTAL PLANE

(71) Applicant: Kenneth Frankel, Issaquah, WA (US)

(72) Inventor: Kenneth Frankel, Issaquah, WA (US)

(21) Appl. No.: 17/840,721

(22) Filed: Jun. 15, 2022

(51) Int. Cl. F41C 3/00; B23K 15/00; B23K 26/26; B23K 26/00

(52) U.S. Cl. CPC F41C 3/00; B23K 15/006; B23K 26/26; B23K 26/0093; B23K 2101/04

(57) ABSTRACT

A method of making a high-end precision gun frame is disclosed. The method includes the steps of providing first and second blanks; machining the first blank to form a left-hand open-face half frame; machining the second blank to form a right-hand open-face half frame complementary and substantially symmetrical to the left-hand half frame; aligning/positioning the left-hand half frame and right-hand half frame such that they confront each other; and high energy beam welding the left-hand open-face half frame and the right-hand open-face half frame together selectively along their interface to form the gun frame. The invention enables the low-cost manufacturing of high-end precision guns of exacting specifications with extremely tight tolerances.

### CROSS-REFERENCE TO RELATED APPLICATION

This application claims the benefit of priority to U.S. Provisional Application No. 63/322,140 filed on Mar. 21, 2022, which application is incorporated herein by reference in its entirety for all purposes.

### TECHNICAL FIELD

The present invention relates generally to guns, and more particularly, to a method for making a high-end precision gun frame having a complex internal geometry by high energy beam welding two opposing pre-machined complementary partial frames along a lengthwise sagittal plane, as well as to gun frames and guns made by said method.

### BACKGROUND OF THE INVENTION

All firearms are guns, which includes any type of tool that fires a projectile. A handgun is a gun that fits in your hand and includes both pistols and revolvers. In general, a pistol has a stationary gun chamber, whereas a revolver has a chamber (cylinder) that spins. In brief, a firearm (a type of gun) is a portable barreled weapon that uses explosive powder (gun powder) to propel a metal projectile (a bullet) towards a target. Firearms include, for example, pistols, revolvers, shotguns, and rifles. As is known in the art, U.S. Pat. No. 12,468 to White discloses a revolver-type of firearm (sometimes referred as a “repeating firearm”), whereas U.S. Pat. No. 4,539,889 to Glock discloses a pistol-type of firearm. Firearms are traditionally and conventionally made by machining and assembling various gun parts together.

Modern handguns typically have four basic parts/components; namely, an action, a gun frame, a clip or cylinder (depending on whether the gun is a pistol or revolver, respectively), and a barrel. The action contains the parts that fire the cartridges (which contain the gun powder and bullets) and includes the trigger. The gun frame is the housing (usually metal) of the gun and includes a hand grip or handle (recognizing that all of the gun's parts are attached to, or resides within, the gun frame). The barrel is a metal tube that protrudes from the frame and projects the bullet.

In the context of pistols, the barrel is longitudinally attached to the action. The action, in turn, is longitudinally attached (often slidably) to the top of gun frame, while the clip or cylinder is fitted within the gun frame. In addition to these basic parts/components, handguns that are pistols generally also include numerous other smaller, more detailed pieces including, for example, front and rear sights, a magazine release, a slide stop, a muzzle, a trigger, a trigger guard, a firing pin, and a hammer. A magazine is an ammunition storage and feeding device for a repeating firearm. The magazine functions by holding several cartridges within itself and sequentially pushing each cartridge into a position where it may be readily loaded into the barrel chamber by the firearm's moving action. The detachable magazine is sometimes colloquially referred to as a “clip”. The manufacturing of well-built and trustworthy guns requires parts that have exacting specifications and tight tolerances. As an aid to understanding the present invention, an illustration of a conventional pistol-type handgun and its various constituent parts is provided as FIG. 1 (prior art).

As is known in the art, the gun frame component of various guns may be manufactured in several different ways. Traditionally, the most common methods include forging, casting, injection molding, and machining. In forging, a metal blank (i.e., a piece of metal sometimes referred to as a billet, stock, or slug) is first forged into a close approximation of its desired final shape. This is done by placing a heated blank into a forging press and impacting it with several hundred tons of force. The impacting of the heated blank within a forging die generally yields an unfinished gun frame having an inexact shape with no internal features. Consequently, and after forging, the gun frame requires subsequent annealing and machining (discussed below) to yield a finished gun frame having an internal geometry with exacting specifications. Gun frames made by casting (a relatively inexpensive process) are less preferred and generally of lower quality because the casting process is dimensionally less accurate and often yields metal parts with microscopic pores and/or air bubbles (that may threaten the strength and integrity of the gun frame). Similarly, injection molding, while cost-effective, yields parts that are similarly dimensional less accurate—thereby precluding their use in high-end precision guns. Consequently, and as is appreciated by those skilled in the art, high-end precision gun frames with complex internal geometries are preferably made by machining—especially CNC (computer numerical control) machining solid metal blanks (of appropriately size and shape depending on the type of gun being manufactured).

CNC machining of single piece solid metal blanks generally yields high quality gun parts. During the cutting process of CNC machining, clamps securely hold a blank of unshaped material in place while a movable milling tool drills and/or cuts into the material to remove excess (similar to the way that sculptures are created from a solid block of stone). As a general rule of thumb, the deeper and more intricate the removal of material from a solid blank, the harder and less dimensional accurate the machining process. Despite of its advantages, CNC machining of gun frames is frequently challenging because most gun frames have internal geometries with intricate features that are difficult to precisely form with conventional cutting tools. Indeed, the CNC machining of solid metal blanks with conventional cutting tools has geometrical limitations.

Although gun manufacturing technology has advanced over the years, there is still a need in the art for new and improved methods for making high-end precision gun frames, especially gun frames with having complex and intricate internal geometries. The present invention fulfills these needs and provides for further related advantages.

### SUMMARY OF THE INVENTION

In brief, the present invention in an embodiment is directed to a method of making a gun frame comprising the steps of: providing first and second blanks; machining the first blank to form a left-hand open-face partial frame; machining the second blank to form a right-hand open-face partial frame that is substantially symmetrical and complementary to the left-hand partial frame; positioning the left-hand partial frame and right-hand partial frame next to, and in contact with, each other along a common sagittal plane such that the left-hand and right-hand partial frames are confronting and adjacent to each other thereby defining an interface therebetween; and selectively applying along their interface a focused high-energy beam having energy density at a focal point of at least 10⁶ W/cm² to thereby weld (fuse) the left-hand and right-hand partial frames together along their interface to form the gun frame (in an unfinished form). The present invention is also directed to finished gun frames and guns (articles of manufacture) made in accordance with the inventive methods disclosed herein.

These and other aspects of the present invention will become more evident upon reference to the following detailed description and accompanying drawings. It is to be understood, however, that various changes, alterations, and substitutions may be made to the specific embodiments disclosed herein. The described and illustrated embodiments are to be considered as illustrative and not restrictive.

### BRIEF DESCRIPTION OF THE DRAWINGS

The drawings are intended to be illustrative of certain preferred embodiments of the present invention (and as such they may not necessarily be drawn to scale). In addition, like reference numerals have been used to designate like parts and features throughout the several views of the drawings.

FIG. 1 shows a cut-away side view of a loaded handgun (including an identification of its constituent parts) manufactured in accordance with the prior art.

FIG. 2 is a block process flow diagram that illustrates the basic process steps associated with making a unified and practically seamless high-end precision gun frame having a complex internal geometry in accordance with an embodiment of the present invention.

FIG. 3 shows a top plan view of a right-hand open-face half frame and a left-hand open-face half frame (post initial machining but pre-welding and with their respective open-faces facing up) in accordance with an embodiment of the present invention.

FIG. 4 shows an elevated perspective view of a right-hand half frame and a left-hand half frame stacked on top of each other (i.e., aligned and positioned next to each other along a common sagittal plane) and securely positioned with short fasteners on a table top prior to being high-energy beam welded together in accordance with an embodiment of the present invention.

FIG. 5 shows an elevated perspective view of a stack of eight stacked half frames securely positioned with long fasteners on a table top prior to being high-energy beam welded together in accordance with an embodiment of the present invention.

FIG. 6 shows an elevated perspective view of an unfinished unified gun frame having a single external slide mount fastening point and two internal handle fastening points (prior to their removal and final finishing) in accordance with an embodiment of the present invention.

FIG. 7 shows an elevated perspective view of a finished unified gun frame having a complex internal geometry made in accordance with an embodiment of the present invention.

### DETAILED DESCRIPTION OF THE INVENTION

The present invention may be understood more completely by reference to the following detailed description of certain preferred embodiments of the invention in view of the accompanying drawings. It is to be understood that the terminology used herein is for the purpose of describing specific embodiments only and is not intended to be limiting. It is further understood that unless specifically defined herein, the terminology used herein is to be given its conventional meaning as understood in the relevant field of technical art. The headings used within this document are to expedite its review by the reader, and should not be construed as limiting the claimed invention in any way. Finally, the disclosures of U.S. Pat. No. 12,468 to White and U.S. Pat. No. 4,539,889 to Glock (relating to guns and gun frames) are each incorporated herein by reference in their entireties.

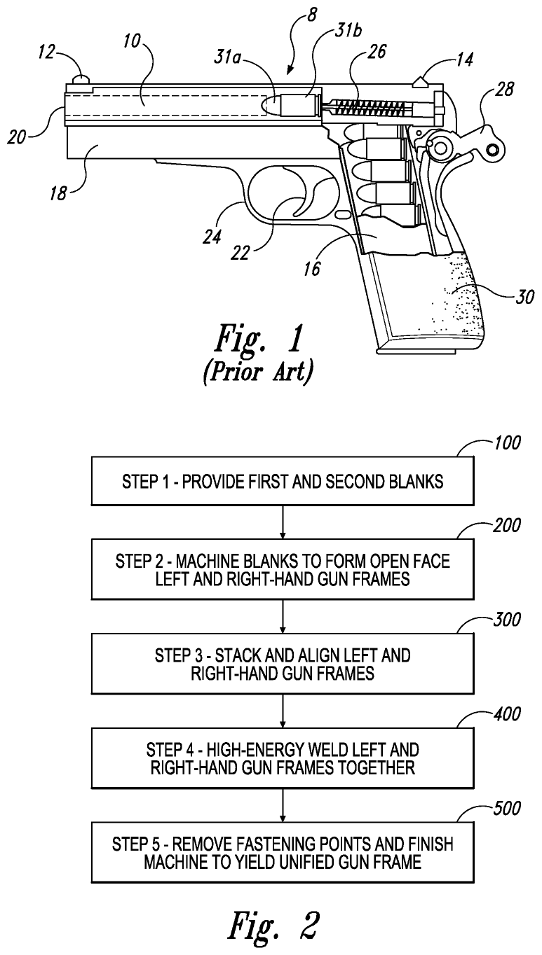

In addition, and as an aid to better understand the invention by the reader, FIG. 1 (prior art) illustrates a cut-away side view of a loaded handgun 8 manufactured (by machining a single metal blank and assembling together various parts) in accordance with the prior art; it shows the handgun's 8 various constituent parts including: a barrel 10, front and rear sights 12, 14, a magazine 16, a slide mount 18, a muzzle 20, a trigger 22, a trigger guard 24, a firing pin 26, a hammer 28, and a handle 30. Because the handgun 8 is loaded, it contains a plurality of bullets 31a fitted onto individual cartridges 31b.

In view of the foregoing, the present invention in an embodiment is directed to a new way of making a high-end precision gun frame having a complex internal geometry. In the several embodiments disclosed herein, the gun frames are shown and described in the context of a pistol. It is to be understood, however, that other types of guns (such as revolvers, for example) are contemplated and within the scope of the invention. In addition, and as used herein the term “sagittal” means a vertical plane passing through an object from front to back that splits the object into left-hand and right-hand objects (which objects may, or more not, be substantially the same in size). In addition, and as used herein, the term “high-energy beam” refers to either (1) a high-energy electron beam having an energy density of at least 10⁶ W/cm², or (2) a high-energy laser beam having an energy density of at least 10⁶ W/cm².

In accordance with the present invention, a high-energy beam (emitted from, for example, the optical head of a high-energy electron beam welder or a high-energy laser beam welder) is used to selectively and seamlessly weld (join) together a pair of confronting and complementary pre-machined open-face partial frames or open-face half frames (along a common lengthwise sagittal plane that defines an interface therebetween). The focal point of the high-energy beam may be selectively positioned at different locations along a weld line, which allows control over the heat input amount and weld characteristics along the interface. In this way, a practically seamless unified single piece gun frame having a complex internal geometry (of extremely tight tolerances) may be manufactured for use, for example, in high-end precision guns used in performance shooting competitions.

Referring now to the further drawings, FIG. 2 illustrates the basic process steps associated with making a single piece high-end precision gun frame having a complex internal geometry (in accordance with a preferred embodiment of the present invention). As illustrated, the inventive method includes the followings steps: (1) Step 1 100— providing first and second blanks of a selected metal or metal alloy; (2) Step 2 200— machining the first and second metal blanks to form an open-face left-hand half frame and an open-face right-hand half frame, wherein the left-hand and right-hand half frames each include internal recesses and are complementary and substantially identical with each other (except that one is essentially a mirror image of the other); (3) Step 3 300— aligning and positioning (i.e., stacking) the machined right-hand and left-hand half frames such that they are confronting and adjacent to each other along a common sagittal plane; (4) Step 4 400— welding together the left-hand and right-hand half frames together by selectively focusing a high-energy beam of either electrons or photons at different positions along their interface; and (5) Step 5 500— further machining and finishing the high-energy beam welded together half frames to remove their fastening points, thereby yielding a finished unified single piece gun frame having a complex internal geometry.

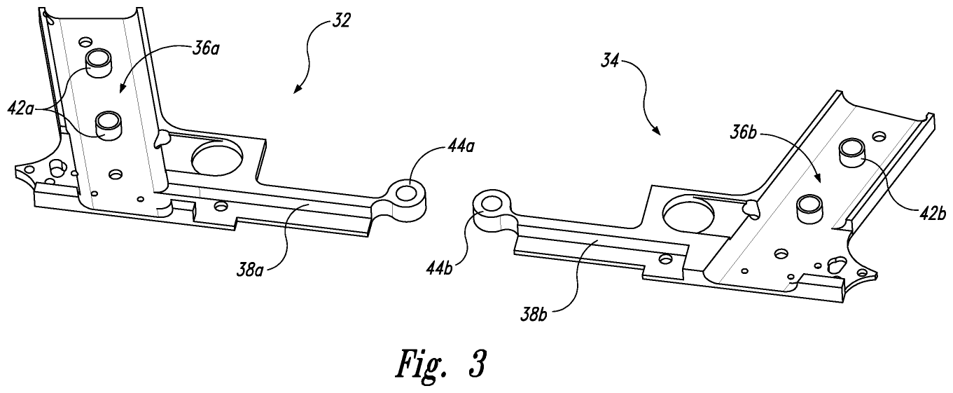

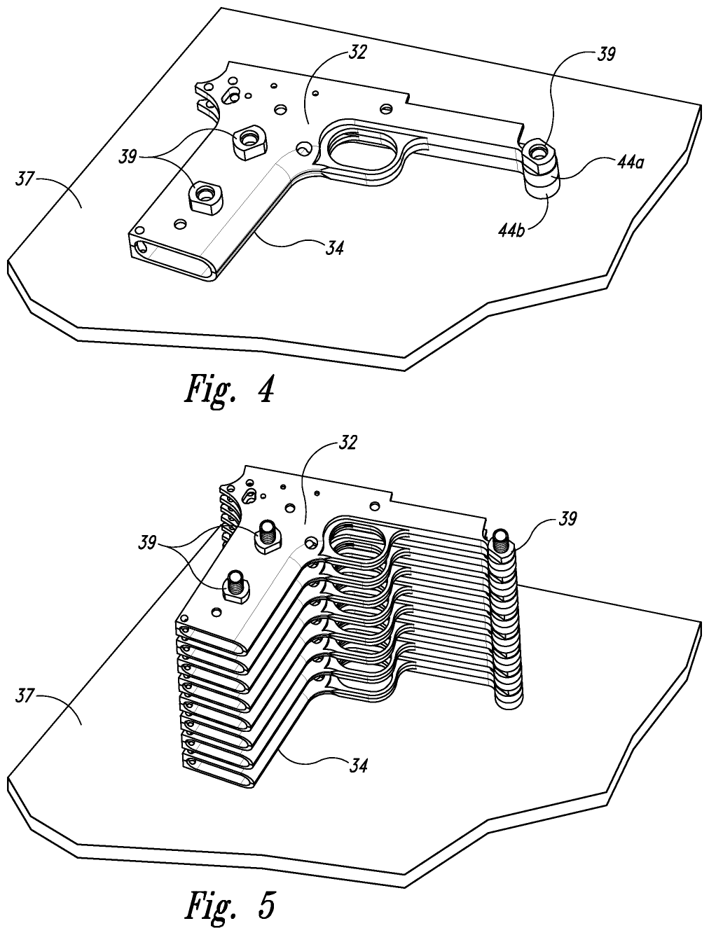

Stated somewhat differently, and as best shown in FIGS. 3 and 4 illustrating further embodiments, the first and second metal blanks (not shown) are each initially machined to form an open face left-hand (sinistral) half frame 32 and an open face right-hand (dextral) half frame 34, respectively. The left-hand and right-hand half frames 32, 34 each are initially machined to include respective hollowed out handle sections 36a, 36b, slide mount sections 38a, 38b extending away from the handle sections 36a, 36b, and trigger guard sections 18a, 18b positioned therebetween. As shown, the open-face left-hand half frame 32 and the open-face right-hand half frame 34 are complementary and substantially identical with each other except that one is essentially a mirror image of the other (or, in other words, they are chiral half frames). In addition, and to aid in the machining and high-energy beam welding processes, the left-hand and right-hand half frames 32, 34 each include two handle fastening points 42a, 42b centrally positioned within the respective handle sections 36a, 36b, as well as a single slide mount fastening points 44a, 44b positioned at the end of the respective slide mount sections 38a, 38b. The handle fastening points 42a, 42b and the slide mount fastening points 44a, 44b are preferably in the form of hollow cylinders (as shown) to thereby enable the half frames 32, 34 to be readily and securely fastened to a table top 37 by means of short cylindrical fasteners 39 as best shown in FIG. 4 (thereby facilitating machining and welding operations).

Next, and as also best shown in FIGS. 4 and 5 and after the initial machining of the blanks, the right-hand open-face half frame 32 and the left-hand open-face half frame 34 are then put together (aligned and positioned next to each other) and further stacked on top of each other and secured onto the table top 37 by means of fasteners 39. A high-energy beam is then selectively applied to the interface between the half frames 32, 34 thereby welding (fusing) the half frames 32, 34 together. Advantageously, and in this way, the pairs of stacked half frames 32, 34 may be joined together to yield a high-end precision single piece gun frame having a complex internal geometry and with virtually no visible weld line.

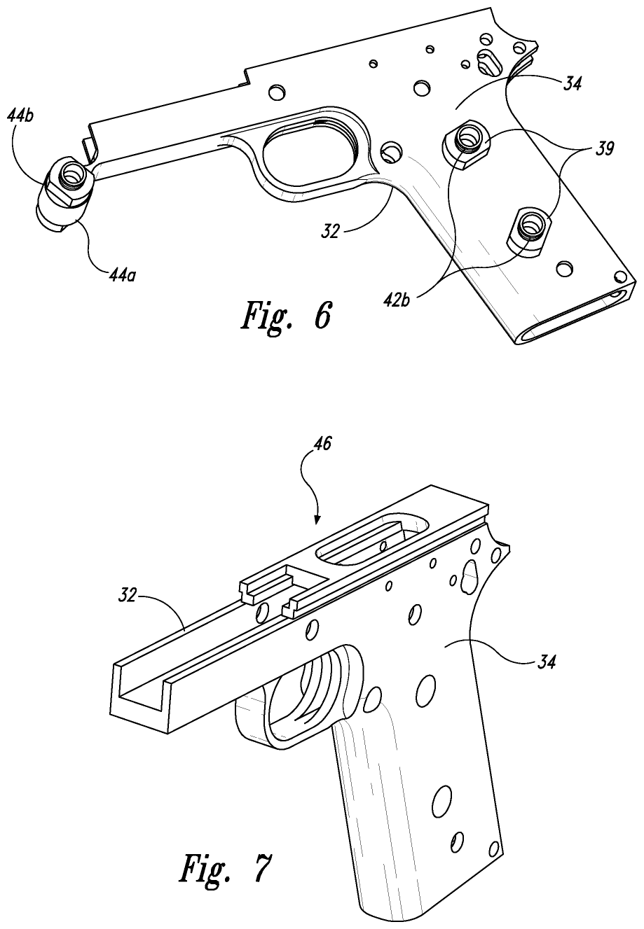

After the high-energy beam welding step, the handle fastening points 42a, 42b and the slide mount fastening points 44a, 44b are removed by further machining, and the combined half frames 32, 34 are finished to thereby yield a unified gun frame 46 having a complex internal geometry as best shown in FIG. 6. The finished unified gun frame 46 may then be assembled with other gun parts to yield a high-end precision gun (not shown) having a complex internal geometry of an exacting specification.

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their scope.

What is claimed is:

1. A method for making a gun frame, comprising the steps of:
providing first and second blanks;
machining the first blank to form a left-hand open-face partial frame;
machining the second blank to form a right-hand open-face partial frame that is complementary and substantially symmetrical to the left-hand open-face partial frame;
positioning the left-hand open-face partial frame and right-hand open-face partial frame next to each other such that their respective open-faces are adjacent to and confronting each other thereby defining an interface therebetween; and
welding the left-hand open-face partial frame and the right-hand open-face partial frame together along the interface by selectively applying a high-energy beam along the interface to thereby yield the gun frame.

2. The method according to claim 1 wherein the first and second blanks are metal blanks.

3. The method according to claim 2 wherein the high-energy beam is selected from a high-energy electron beam and a high-energy laser beam.

4. The method according to claim 3 wherein the high-energy beam has an energy density at a focal point of at least 10⁶ W/cm².

5. The method according to claim 4 wherein (i) the left-hand open-face partial frame is a left-hand half frame, and (ii) the right-hand open-face partial frame is a right-hand half frame.

6. The method according to claim 5 wherein the left-hand open-face half frame includes a left-hand handle section and a left-hand slide mount section extending away from the left-hand handle section, wherein the left-hand handle section includes a left-hand recess having one or more left-hand handle fixture points positioned within the left-hand recess, and wherein the left-hand slide mount section includes a left-hand mount fixture point positioned at the end of the left-hand mount section.

7. The method according to claim 6 wherein the right-hand open-face half frame includes a right-hand handle section and a right-hand slide mount section extending away from the right-hand handle section, wherein the right-hand handle section includes a right-hand recess having one or more right-hand handle fixture points positioned within the right-hand recess, and wherein the right-hand slide mount section includes a right-hand slide mount fixture point positioned at the end of the right-hand mount section.

8. The method according to claim 7, further comprising removing the one or more handle fixture points and the slide mount fixture points from the welded together half frames to yield the gun frame.

9. A gun frame made in accordance with claim 1.

10. A gun comprising a gun frame made in accordance with claim 1.
